(19) United States
(12) Patent Application Publication
(10) Pub. No.: US 2012/0229103 A1
(43) Pub. Date: Sep. 13, 2012

(54) SIGNAL COMPENSATION METHOD FOR MAGNETICALLY SENSITIVE POSITION FEEDBACK DEVICE

(76) Inventors: Ming-Fu TSAI, Taichung City (TW); Cheng-Min LAI, Taichung City (TW)

(21) Appl. No.: 13/044,454

(22) Filed: Mar. 9, 2011

(51) Int. Cl. G05F 1/10

(52) U.S. Cl. 323/234

(57) ABSTRACT

Signal compensation method for magnetically sensitive position feedback device in which the compensation for voltage offset is performed in accordance with the following formula (1), while the compensation for voltage amplitude is performed in accordance with the following formula (2):

Voffset=(PreMaxV)/4+(NextMaxV)/4+(MaxV)/2, formula (1)

wherein:
Voffset is the voltage offset of the half-wave of the current position,
PreMaxV is the maximum positive (negative) voltage of the preceding half-wave to the half-wave of the current position,
NextMaxV is the maximum positive (negative) voltage of the next half-wave from the half-wave of the current position, and
MaxV is the maximum negative (positive) voltage of the half-wave of the current position.

Vamp=K/Abs(((PreMaxV/4+(NextMaxV)/4)−(MaxV)/2), formula (2)

wherein:
Vamp is the voltage amplitude ratio constant of the half-wave of the current position,
K is the necessary amplitude value,
PreMaxV is the maximum positive (negative) voltage of the preceding half-wave to the half-wave of the current position,
NextMaxV is the maximum positive (negative) voltage of the next half-wave from the half-wave of the current position, and
MaxV is the maximum negative (positive) voltage of the half-wave of the current position.

### BACKGROUND OF THE INVENTION

1. Field of the Invention

The present invention relates generally to a control technique for rotary motor, and more particularly to a signal compensation method for magnetically sensitive position feedback device.

2. Description of the Related Art

A conventional position feedback device is used to obtain signals related to the operation of a rotary motor for achieving best control of the rotary motor. The position feedback device is able to sense the rotational position of the motor and feed back the position signals to a control device. According to the signals, the control device controls the operation of the motor.

To speak more specifically, in the conventional position feedback technique, a magnetic member is disposed at an end of the rotary shaft of the rotary motor and synchronously rotatable therewith. Multiple magnetic sectors of south and north poles are alternately arranged on the magnetic member around the rotary shaft of the motor. Magnetically sensitive elements such as read heads or Hall elements are used to sense magnetic field change and output corresponding signals to the control device. The control device then properly controls the motor on the basis of the feedback signals.

The assembly precision of the motor is affected by the factors of precision of the components of the motor themselves, fit tolerance, installation, processing, etc. Therefore, after captured, the feedback signals must be compensated to offset the distortion of the signals. The compensation can be performed on the basis of the actual position or fixed value of sine/cosine signals.

In the conventional technique, when performing compensation on the basis of the actual position, a memory with considerably large capacity is needed to store the position compensation table. Moreover, such position compensation table is established with respect to individual motor and is not adaptable to a different motor. Therefore, it is quite troublesome and inconvenient to establish the position compensation table. Furthermore, with respect to a specific motor, the corresponding position compensation table is unchanged and established at the releasing time of the motor. After a period of time from the release of the motor from the factory, the motor is often mechanically worn. In this case, the position compensation table established at the releasing time of the motor will fail to meet the actual situation of the motor after used. Even if the sensed signals are compensated, the signals will remain in a distorted state.

In addition, with respect to the conventional technique of compensation on the basis of fixed value of sine/cosine wave, the compensation is affected by the factors of processing precision of the silicon steel sheets, bending deformation of the silicon steel sheets, adhesion of the silicon steel sheets, assembly precision, etc. These factors must be controlled to be higher than a standard value for sensing the voltage offset of the sensed voltage and keeping the voltage amplitude constant.

### SUMMARY OF THE INVENTION

It is therefore a primary object of the present invention to provide a signal compensation method for magnetically sensitive position feedback device. By means of the method, the sensed signals can be compensated for non-constant value of voltage offset and fixed voltage amplitude to achieve optimal feedback sine/cosine signals.

To achieve the above and other objects, in the signal compensation method for magnetically sensitive position feedback device of the present invention, the compensation for voltage offset is performed in accordance with the following formula (1), while the compensation for voltage amplitude is performed in accordance with the following formula (2):

Voffset=(PreMaxV)/4+(NextMaxV)/4+(MaxV)/2, formula (1)

### Wherein:

Voffset is the voltage offset of the half-wave of the current position,
PreMaxV is the maximum positive (negative) voltage of the preceding half-wave to the half-wave of the current position,
NextMaxV is the maximum positive (negative) voltage of the next half-wave from the half-wave of the current position, and
MaxV is the maximum negative (positive) voltage of the half-wave of the current position.

Vamp=K/Abs(((PreMaxV/4+(NextMaxV)/4)−(MaxV)/2), formula (2)

wherein:
Vamp is the voltage amplitude ratio constant of the half-wave of the current position,
K is the necessary amplitude value,
PreMaxV is the maximum positive (negative) voltage of the preceding half-wave to the half-wave of the current position,
NextMaxV is the maximum positive (negative) voltage of the next half-wave from the half-wave of the current position, and
MaxV is the maximum negative (positive) voltage of the half-wave of the current position.

The present invention can be best understood through the following description and accompanying drawings, wherein:

### DETAILED DESCRIPTION OF THE PREFERRED EMBODIMENTS

The embodiment of the signal compensation method for magnetically sensitive position feedback device of the present invention is described as follows:

Substantially, the signal compensation method for magnetically sensitive position feedback device of the present invention is applied to an annular magnetically sensitive position feedback device for compensating the position feedback signals thereof. The magnetically sensitive position feedback device includes an annular magnetic element coaxially disposed at one end of the rotary shaft of a rotary motor and synchronously rotatable with the rotor of the rotary motor. The magnetically sensitive position feedback device further includes at least one fixed sensing element for sensing magnetic field change taking place when the magnetic element rotates. The magnetically sensitive position feedback device pertains to prior art and is well known by those who are skilled in this field and thus will not be further described hereinafter.

The signal compensation method for magnetically sensitive position feedback device of the present invention is an autonomous signal compensation method. In this method, the average value of the maximum voltage of the half-wave of the current position sensed by the magnetically sensitive position feedback device, the maximum voltage of the preceding half-wave to the half-wave of the current position and the maximum voltage of the next half-wave from the half-wave of the current position is taken as the non-constant voltage offset compensation of the current position and as the basis for the compensation of the constant voltage amplitude of the current position. For example, the following Table 1 shows the values of the signals actually sensed by the magnetically sensitive position feedback device:

TABLE 1
sine/cosine signal original peak values

| | | sine signals | cosine signals |
|---|---|---|---|
| 1^{st} tooth | positive | 1.796264648 | 1.433563232 |
| | peak | | |
| | value | | |
| | negative | −1.619567871 | −1.879577637 |
| | peak | | |
| | value | | |
| 2^{nd} tooth | positive | 1.808853149 | 1.420974731 |
| | peak | | |
| | value | | |
| | negative | −1.622161865 | −1.893005371 |
| | peak | | |
| | value | | |
| 3^{rd} tooth | positive | 1.808853149 | 1.411514282 |
| | peak | | |
| | value | | |
| | negative | −1.631393433 | −1.895980835 |
| | peak | | |
| | value | | |
| 4^{th} tooth | positive | 1.816635132 | 1.397171021 |
| | peak | | |
| | value | | |
| | negative | −1.631393433 | −1.916503906 |
| | peak | | |
| | value | | |
| 5^{th} tooth | positive | 1.825637817 | 1.38420105 |
| | peak | | |
| | value | | |
| | negative | −1.590423584 | −1.916275024 |
| | peak | | |
| | value | | |
| 6^{th} tooth | positive | 1.842880249 | 1.370544434 |
| | peak | | |
| | value | | |
| | negative | −1.573028564 | −1.900177002 |
| | peak | | |
| | value | | |
| 7^{th} tooth | positive | 1.853103638 | 1.361618042 |
| | peak | | |
| | value | | |
| | negative | −1.560821533 | −1.90612793 |
| | peak | | |
| | value | | |
| 8^{th} tooth | positive | 1.865997314 | 1.377792358 |
| | peak | | |
| | value | | |
| | negative | −1.560821533 | −1.908187866 |
| | peak | | |
| | value | | |
| 9^{th} tooth | positive | 1.865997314 | 1.377792358 |
| | peak | | |
| | value | | |
| | negative | −1.554946899 | −1.908187866 |
| | peak | | |
| | value | | |
| 10^{th} tooth | positive | 1.878814697 | 1.377639771 |
| | peak | | |
| | value | | |
| | negative | −1.544723511 | −1.913223267 |
| | peak | | |
| | value | | |
| 11^{th} tooth | positive | 1.884918213 | 1.379394531 |
| | peak | | |
| | value | | |
| | negative | −1.529083252 | −1.890945435 |
| | peak | | |
| | value | | |
| 12^{th} tooth | positive | 1.888809204 | 1.399383545 |
| | peak | | |
| | value | | |
| | negative | −1.506195068 | −1.863327026 |
| | peak | | |
| | value | | |
| 13^{th} tooth | positive | 1.889953613 | 1.422195435 |
| | peak | | |
| | value | | |
| | negative | −1.508560181 | −1.847915649 |
| | peak | | |
| | value | | |
| 14^{th} tooth | positive | 1.886749268 | 1.427154541 |
| | peak | | |
| | value | | |
| | negative | −1.517868042 | −1.837310791 |
| | peak | | |
| | value | | |
| 15^{th} tooth | positive | 1.893157959 | 1.434173584 |
| | peak | | |
| | value | | |
| | negative | −1.527175903 | −1.835327148 |
| | peak | | |
| | value | | |
| 16^{th} tooth | positive | 1.88331604 | 1.457824707 |
| | peak | | |
| | value | | |
| | negative | −1.533203125 | −1.82182312 |
| | peak | | |
| | value | | |
| 17^{th} tooth | positive | 1.870117188 | 1.467895508 |
| | peak | | |
| | value | | |
| | negative | −1.535263062 | −1.79649353 |
| | peak | | |
| | value | | |
| 18^{th} tooth | positive | 1.846237183 | 1.453781128 |
| | peak | | |
| | value | | |
| | negative | −1.565170288 | −1.793136597 |
| | peak | | |
| | value | | |
| 19^{th} tooth | positive | 1.829910278 | 1.459579468 |
| | peak | | |
| | value | | |
| | negative | −1.574172974 | −1.787033081 |
| | peak | | |
| | value | | |

With respect to the compensation of the position feedback signals, the compensation for voltage offset is performed in accordance with the following formula (1):

Voffset=(PreMaxV)/4+(NextMaxV)/4+(MaxV)/2, formula (1)

wherein:
Voffset is the voltage offset of the half-wave of the current position,
PreMaxV is the maximum positive (negative) voltage of the preceding half-wave to the half-wave of the current position,
NextMaxV is the maximum positive (negative) voltage of the next half-wave from the half-wave of the current position, and
MaxV is the maximum negative (positive) voltage of the half-wave of the current position.

When the voltage of the half-wave of the current position is positive, the average value of the maximum negative voltage of the preceding half-wave to the half-wave of the current position and the maximum negative voltage of the next half-wave from the half-wave of the current position and the maximum positive voltage of the half-wave of the current position is taken as the voltage offset compensation of the half-wave of the current position. When the voltage of the half-wave of the current position is negative, the average value of the maximum positive voltage of the preceding half-wave to the half-wave of the current position and the maximum positive voltage of the next half-wave from the half-wave of the current position and the maximum negative voltage of the half-wave of the current position is taken as the voltage offset compensation of the half-wave of the current position. Accordingly, the voltage offset compensation of the above Table 1 is as shown in the following Table 2:

TABLE 2
sine/cosine signal voltage offset compensation

| | | | cosine signal |
|---|---|---|---|
| | | sine signal voltage | voltage offset |
| | | offset compensation | compensation |
| 1^{st} | positive | 0.099697113 | −0.199871063 |
| tooth | peak | | |
| | value | | |
| | negative | 0.091495514 | −0.226154327 |
| | peak | | |
| | value | | |
| 2^{nd} | positive | 0.093994141 | −0.232658386 |
| tooth | peak | | |
| | value | | |
| | negative | 0.093345642 | −0.238380432 |
| | peak | | |
| | value | | |
| 3^{rd} | positive | 0.09103775 | −0.24148941 |
| tooth | peak | | |
| | value | | |
| | negative | 0.090675354 | −0.245819092 |
| | peak | | |
| | value | | |
| 4^{th} | positive | 0.09262085 | −0.254535675 |
| tooth | peak | | |
| | value | | |
| | negative | 0.094871521 | −0.262908936 |
| | peak | | |
| | value | | |
| 5^{th} | positive | 0.107364655 | −0.266094208 |
| tooth | peak | | |
| | value | | |
| | negative | 0.121917725 | −0.269451141 |
| | peak | | |
| | value | | |
| 6^{th} | positive | 0.130577087 | −0.26884079 |
| tooth | peak | | |
| | value | | |
| | negative | 0.137481689 | −0.267047882 |
| | peak | | |
| | value | | |
| 7^{th} | positive | 0.143089294 | −0.270767212 |
| tooth | peak | | |
| | value | | |
| | negative | 0.149364471 | −0.268211365 |
| | peak | | |
| | value | | |
| 8^{th} | positive | 0.152587891 | −0.26468277 |
| tooth | peak | | |
| | value | | |
| | negative | 0.152587891 | −0.265197754 |
| | peak | | |
| | value | | |
| 9^{th} | positive | 0.154056549 | −0.265197754 |
| tooth | peak | | |
| | value | | |
| | negative | 0.158729553 | −0.265235901 |
| | peak | | |
| | value | | |
| 10^{th} | positive | 0.164489746 | −0.266532898 |
| tooth | peak | | |
| | value | | |
| | negative | 0.168571472 | −0.267353058 |
| | peak | | |
| | value | | |
| 11^{th} | positive | 0.174007416 | −0.26134491 |
| tooth | peak | | |
| | value | | |
| | negative | 0.178890228 | −0.250778198 |
| | peak | | |
| | value | | |
| 12^{th} | positive | 0.185585022 | −0.238876343 |
| tooth | peak | | |
| | value | | |
| | negative | 0.19159317 | −0.226268768 |
| | peak | | |
| | value | | |
| 13^{th} | positive | 0.191287994 | −0.216712952 |
| tooth | peak | | |
| | value | | |
| | negative | 0.18989563 | −0.211620331 |
| | peak | | |
| | value | | |
| 14^{th} | positive | 0.186767578 | −0.20772934 |
| tooth | peak | | |
| | value | | |
| | negative | 0.186042786 | −0.203323364 |
| | peak | | |
| | value | | |
| 15^{th} | positive | 0.185317993 | −0.201072693 |
| tooth | peak | | |
| | value | | |
| | negative | 0.180530548 | −0.194664001 |
| | peak | | |
| | value | | |
| 16^{th} | positive | 0.176563263 | −0.185375214 |
| tooth | peak | | |
| | value | | |
| | negative | 0.171756744 | −0.179481506 |
| | peak | | |
| | value | | |
| 17^{th} | positive | 0.167942047 | −0.170631409 |
| tooth | peak | | |
| | value | | |
| | negative | 0.161457062 | −0.167827606 |
| | peak | | |
| | value | | |
| 18^{th} | positive | 0.148010254 | −0.170516968 |
| tooth | peak | | |
| | value | | |
| | negative | 0.136451721 | −0.168228149 |
| | peak | | |
| | value | | |
| 19^{th} | positive | 0.130119324 | −0.165252686 |
| tooth | peak | | |
| | value | | |
| | negative | 0.119457245 | −0.170230865 |
| | peak | | |
| | value | | |

With respect to the compensation for the voltage amplitude of the position feedback signals, it is ensured that the sensed voltage amplitude of every half-wave is constant under a preset constant amplitude according to the following formula (2):

Vamp=K/Abs(((PreMaxV/4+(NextMaxV)/4)−(MaxV)/2), formula (2)

wherein:
Vamp is the voltage amplitude ratio constant of the half-wave of the current position,
K is the necessary amplitude value,
PreMaxV is the maximum positive (negative) voltage of the preceding half-wave to the half-wave of the current position,
NextMaxV is the maximum positive (negative) voltage of the next half-wave from the half-wave of the current position, and
MaxV is the maximum negative (positive) voltage of the half-wave of the current position.

When the voltage of the half-wave of the current position is positive, the average value of the maximum negative voltage of the preceding half-wave to the half-wave of the current position and the maximum negative voltage of the next half-wave from the half-wave of the current position and the maximum positive voltage of the half-wave of the current position is taken as the basis for the voltage amplitude compensation of the half-wave of the current position. When the voltage of the half-wave of the current position is negative, the average value of the maximum positive voltage of the preceding half-wave to the half-wave of the current position and the maximum positive voltage of the next half-wave from the half-wave of the current position and the maximum negative voltage of the half-wave of the current position is taken as the basis for the voltage amplitude compensation of the half-wave of the current position. Accordingly, with respect to the voltage amplitude compensation of the above Table 1, the value of K in formula (2) is set 1.8 and the corresponding voltage amplitude compensation is as shown in the following Table 3:

TABLE 3
sine/cosine signal voltage amplitude ratios

| | | | cosine signal |
|---|---|---|---|
| | | sine signal voltage | voltage amplitude |
| | | amplitude ratios | ratios |
| 1^{st} | positive | 1.060965722 | 1.101972699 |
| | peak | | |
| | value | | |
| | | 1.051977394 | 1.088650432 |
| 2^{nd} | positive | 1.049648975 | 1.088512307 |
| | peak | | |
| | value | | |
| | | 1.049252185 | 1.087859827 |
| 3^{rd} | positive | 1.04784251 | 1.088926787 |
| | peak | | |
| | value | | |
| | | 1.045254414 | 1.090802164 |
| 4^{th} | positive | 1.044074877 | 1.089781863 |
| | peak | | |
| | value | | |
| | | 1.042713632 | 1.088537418 |
| 5^{th} | positive | 1.047563355 | 1.090713914 |
| | peak | | |
| | value | | |
| | negative | 1.051192301 | 1.093013053 |
| | peak | | |
| | value | | |
| 6^{th} | positive | 1.051215719 | 1.097972566 |
| | peak | | |
| | value | | |
| | negative | 1.052317574 | 1.10217862 |
| | peak | | |
| | value | | |
| 7^{th} | positive | 1.05262275 | 1.102680875 |
| | peak | | |
| | value | | |
| | negative | 1.052517092 | 1.098957077 |
| | peak | | |
| | value | | |
| 8^{th} | positive | 1.050537002 | 1.095907006 |
| | peak | | |
| | value | | |
| | negative | 1.050537002 | 1.095563501 |
| | peak | | |
| | value | | |
| 9^{th} | positive | 1.051438249 | 1.095563501 |
| | peak | | |
| | value | | |
| | negative | 1.050373305 | 1.095588939 |
| | peak | | |
| | value | | |
| 10^{th} | positive | 1.049975968 | 1.094775527 |
| | peak | | |
| | value | | |
| | negative | 1.050607174 | 1.093646383 |
| | peak | | |
| | value | | |
| 11^{th} | positive | 1.052071214 | 1.097066332 |
| | peak | | |
| | value | | |
| | negative | 1.053880532 | 1.097449065 |
| | peak | | |
| | value | | |
| 12^{th} | positive | 1.05681919 | 1.098726773 |
| | peak | | |
| | value | | |
| | negative | 1.060202892 | 1.099533258 |
| | peak | | |
| | value | | |
| 13^{th} | positive | 1.059655285 | 1.098292019 |
| | peak | | |
| | value | | |
| | negative | 1.059786183 | 1.100045927 |
| | peak | | |
| | value | | |
| 14^{th} | positive | 1.058834934 | 1.100995625 |
| | peak | | |
| | value | | |
| | negative | 1.05639331 | 1.101599664 |
| | peak | | |
| | value | | |
| 15^{th} | positive | 1.053962922 | 1.100751627 |
| | peak | | |
| | value | | |
| | negative | 1.054045324 | 1.097117348 |
| | peak | | |
| | value | | |
| 16^{th} | positive | 1.054634288 | 1.095423617 |
| | peak | | |
| | value | | |
| | negative | 1.055743324 | 1.095996098 |
| | peak | | |
| | value | | |
| 17^{th} | positive | 1.057470502 | 1.098547715 |
| | peak | | |
| | value | | |
| | negative | 1.060870308 | 1.10519903 |
| | peak | | |
| | value | | |
| 18^{th} | positive | 1.059929017 | 1.108170972 |
| | peak | | |
| | value | | |
| | negative | 1.057814244 | 1.107754719 |
| | peak | | |
| | value | | |
| 19^{th} | positive | 1.058953747 | 1.107806733 |
| | peak | | |
| | value | | |
| | negative | 1.062805789 | 1.113308717 |
| | peak | | |
| | value | | |

In conclusion, according to the signal compensation method for magnetically sensitive position feedback device of the present invention, only a small-capacity memory is needed as a database for the voltage values of the half-waves. In addition, the database is synchronously updated with the operation of the motor. In comparison with the conventional technique, the necessary capacity of the memory is minified and the used voltage value data more conform to the real use state of the motor. In this case, the distortion due to mechanical factors after a period of use of the motor can be avoided. Furthermore, the signal compensation method for magnetically sensitive position feedback device of the present invention is applicable to various motors. Therefore, even if the value of the induced voltage of the half-wave varies with the processing or assembling adhesion precision of the silicon steel sheets of the motors, the signal compensation method for magnetically sensitive position feedback device of the present invention can still provide compensation effect for the motors. Therefore, it is unnecessary to independently establish large-capacity and non-autonomous position compensation tables for respective motors as in the conventional technique. Apparently, the signal compensation method for magnetically sensitive position feedback device of the present invention is advantageous over the conventional technique.

The above embodiments are only used to illustrate the present invention, not intended to limit the scope thereof. Many modifications of the above embodiments can be made without departing from the spirit of the present invention.

What is claimed is:

1. A signal compensation method for magnetically sensitive position feedback device in which the compensation for voltage offset is performed in accordance with the following formula (1), while the compensation for voltage amplitude is performed in accordance with the following formula (2):
Voffset=(PreMaxV)/4+(NextMaxV)/4+(MaxV)/2, formula (1)
wherein:
Voffset is the voltage offset of the half-wave of the current position,
PreMaxV is the maximum positive (negative) voltage of the preceding half-wave to the half-wave of the current position,
NextMaxV is the maximum positive (negative) voltage of the next half-wave from the half-wave of the current position, and
MaxV is the maximum negative (positive) voltage of the half-wave of the current position.
Vamp=K/Abs(((PreMaxV/4+(NextMaxV)/4)−(MaxV)/2), formula (1)
wherein:
Vamp is the voltage amplitude ratio constant of the half-wave of the current position,
K is the necessary amplitude value,
PreMaxV is the maximum positive (negative) voltage of the preceding half-wave to the half-wave of the current position,
NextMaxV is the maximum positive (negative) voltage of the next half-wave from the half-wave of the current position, and
MaxV is the maximum negative (positive) voltage of the half-wave of the current position.

2. The signal compensation method for magnetically sensitive position feedback device as claimed in claim 1, where the method is applied to an annular magnetically sensitive position feedback device for compensating the position feedback signals thereof.
